(19) United States
(12) Patent Application Publication
(10) Pub. No.: US 2026/0236341 A1
(43) Pub. Date: Aug. 13, 2026

(54) END-TO-END RECONCILIATION SYSTEMS AND METHODS

(71) Applicant: Smarsh Inc., PORTLAND, OR (US)

(72) Inventor: Abhishek Minocha, PORTLAND, OR (US)

(21) Appl. No.: 19/464,475

(22) Filed: Jan. 29, 2026

Related U.S. Application Data
(60) Provisional application No. 63/756,500, filed on Feb. 10, 2025.

(51) Int. Cl. G06F 11/07; G06F 11/1471

(52) U.S. Cl. CPC G06F 11/0793; G06F 11/1471

(57) ABSTRACT

A computing device can receive first data objects corresponding to communication modalities. The computing device can store first log entries individually corresponding to a respective one of the first data objects. The computing device can receive second data objects, generated based in part on one or more of the first data objects. The computing device can store second log entries individually corresponding to a respective one of the second data objects. The computing device can receive third data objects, generated based in part on one or more of the second data objects. The computing device can store third log entries individually corresponding to a respective one of the third data objects. The computing can identify a failure to process one of the first data objects based on the second data objects and the third data objects and perform a remedial action.

### CROSS-REFERENCE TO RELATED APPLICATION

This application claims the benefit of, and priority to, U.S. Provisional Application No. 63/756,500, filed on February 10, 2025, and entitled “END-TO-END RECONCILIATION SYSTEMS AND METHODS,” which is hereby incorporated by reference in its entirety.

### TECHNICAL FIELD

The present systems and processes relate to capturing, archiving, and reconciling digital communications across multiple communication channels.

### BACKGROUND

Communication within an organization can take place across multiple channels. For example, employees can send emails, text messages, direct messages on messaging, collaboration (e.g., Slack®, Microsoft Teams®, Zoom®) and social media platforms, share documents, and conduct audio and video calls. Each communication channel (e.g., email, text, direct message, collaboration, audio, video) may be provided by multiple, different service providers and can generate massive amounts of complex data in stored in different formats and in various, disconnected storage locations. However, organizations are often expected to provide communications and documents in response to discovery requests and compliance requirements. In particular, discovery requests and compliance often require that communications are provided promptly and in their original form. Further, organizations have an interest in supervising employee activity, both to ensure compliance with organization and legal policies and to analyze business performance.

In some cases, supervision and surveillance capabilities may not integrate with differing or multiple channels or store communications in a centralized storage location. Further, supervision and surveillance solutions may not capture all communications from all channels. For example, solutions may be unable to integrate with all channels or may experience difficulties capturing complex or large communications (e.g., emails with large attachments, conversation threads across multiple channels, communications on collaboration platforms interacting with documents). As another example, solutions may not be able to reconcile communications missing from archives with communications captured from communication channels (e.g., some communications may be captured, but not archived, and unable to be produced in response to a discovery request or compliance requirement). Therefore, there is a long-felt but unresolved need for a single supervision and surveillance system capable of capturing and archiving every communication across multiple, differing communication channels.

### BRIEF SUMMARY OF THE DISCLOSURE

Briefly described, and according to one embodiment, aspects of the present disclosure generally relate to capturing and archiving every data object (e.g., communication generated by a communication channel) across multiple communication channels (e.g., communication modalities). The disclosed systems can ensure that every data object generated by a communication channel is captured and archived in a centralized, write once, read many (“WORM”) storage (e.g., once the data object has been archived in WORM storage, the data object may not be modified or deleted). For example, the disclosed system can reconcile the captured data objects with the archived data objects and can confirm that every captured data object has been properly archived. As another example, the data objects can be archived in a centralized data store, such that data objects from different communication modalities can be stored in a single, centralized location. As another example, the archived data objects can be indexed, such that archived data objects can be tagged, searched, and produced in response to compliance requirements and discovery requests.

As will be understood, the data objects can include any communication generated by a communication modality (e.g., a communication channel). For example, the data objects can include, but is not limited to, emails, text messages, direct messages from messaging, social media, and collaboration platforms (e.g., Slack®, Microsoft Teams®, Zoom®), audio and video calls and messages. As another example, the data objects can include attachments and shared documents and conversation threads (e.g., a thread of messages and responses among multiple users). For example, the communication modalities can include email platforms, mobile devices, messaging, social media, and collaboration platforms (e.g., Slack®, Microsoft Teams®, Zoom®), voice platforms, document sharing platforms, and any platform capable of transmitting communications among multiple users. The disclosed system can associate data objects from different communication modalities. For example, users can start a conversation on a first communication modality and then continue the conversation on a second communication modality. The disclosed system can associate the data object generated by the first communication modality with the data object generated by the second communication modality.

The above and further features of the disclosed systems and methods will be recognized from the following detailed descriptions and drawings of various embodiments.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an end-to-end reconciliation system according to various embodiments of the present disclosure.

FIG. 2 illustrates an exemplary networked environment for the disclosed system according to various embodiments of the present disclosure.

FIG. 3 illustrates an exemplary capture process for the disclosed system according to various embodiments of the present disclosure.

FIG. 4 illustrates an exemplary archive process for the disclosed system according to various embodiments of the present disclosure.

FIG. 5 illustrates an exemplary remediation process for the disclosed system according to various embodiments of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to capturing and archiving every data object (e.g., communication generated by a communication channel) across multiple communication channels (e.g., communication modalities). The data objects can be transmitted by the communication modalities to a capture service each time the communication modalities generate a communication. The capture service can normalize the data objects into a predefined data structure with predefined fields and formats. The capture service can fetch metadata and add the metadata to the fields in the predefined data structure. The capture service can export the data objects in preparation of the archive process.

An archive service can retrieve the export data objects via an API call and place the data objects in a queue for processing. Once the archive service has capacity to process the data objects, the archive service can retrieve the data objects from the queue. The archive service can perform data processing on the data objects, including but not limited to, extracting documents and attachments, identifying a state associated with the data objects, and associated data objects. The data objects can be archived in write once, read many storage and may not deleted or modified once archived. The archived data objects can be indexed by creating a directory using the metadata as tags.

Log entries can be created at different points during the capture and archive process. The log entries can be compared to determine if every data object transmitted by a communication modality has been archived. For example, log entries can be generated by the communication modalities as a record of each data object transmitted by the communication modalities. Log entries can be generated by the capture process as a record of the data objects that have completed the capture process. Log entries can be generated by the archive process as a record of the data objects have undergone data processing and are ready for archive. The generated log entries can be compared to the archived data objects to identify missing data objects and the associated error. The associated error can be remediated and the missing data objects can be archived.

### Exemplary Embodiments

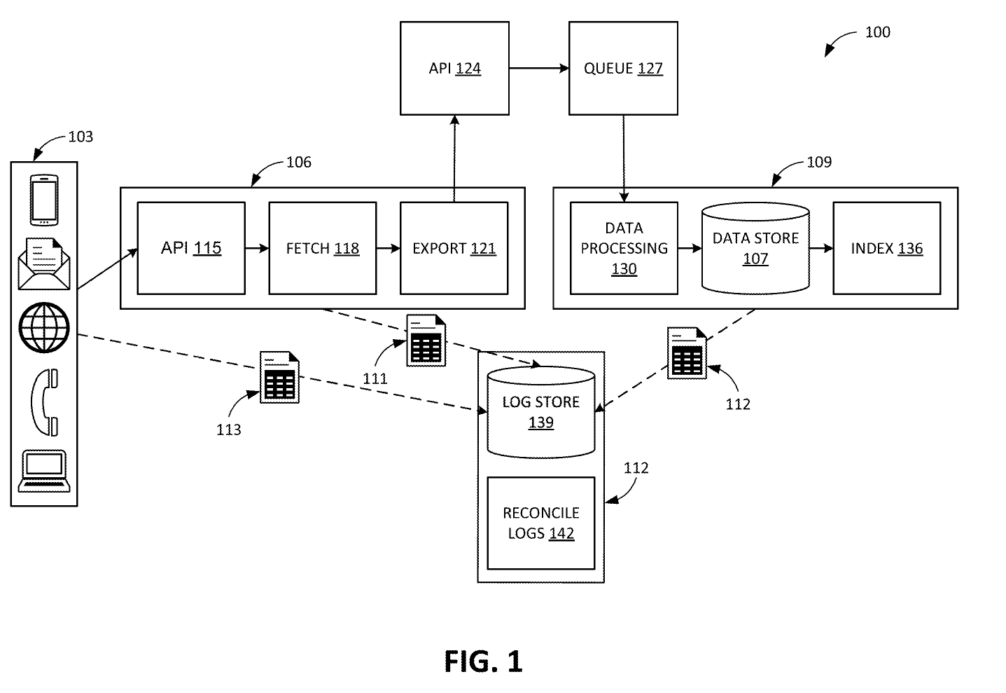

Referring now to the figures, for the purposes of example and explanation of the fundamental processes and components of the disclosed systems and processes, reference is made to FIG. 1, which illustrates the exemplary end-to-end reconciliation system 100 (“system 100”). The system 100 can capture data objects from multiple communication modalities 103 using the capture process 106 and archive the data objects in the data store 107 using the archive process 109. The data store 107 can include write once, read many (“WORM”) storage (e.g., once the data object has been archived in the data store 107, the data object may not be modified or deleted).

The capture process 106 and the archive process 109 can generate log entries 111 and 112. In some embodiments, the log entries 111, 112 can represent the data objects received at the capture process 106 and/or the archive process 109. In some other embodiments, the log entries can represent the data objects that have completed the capture process 106 and/or the archive process 109. In some other embodiments, the system 100 can request and receive log entries 113 from the communication modalities 103 representing the data objects generated by the communication modalities 103. The log entries from the capture process 106, the archive process 109, and the communication modalities 103 can be reconciled using the reconciliation process 114. The reconciliation process 114 can confirm that each data object generated by a communication modality 103 has been archived in the data store 107.

The communication modalities 103 can generate data objects. As will be understood, the data objects can include any communications generated by the communication modalities 103 (e.g., emails, text messages, direct messages, audio and video calls and messages, conversation threads, attachments, shared documents). The system 100 can receive the data objects from the communication modalities 103 using the capture process 106. As used herein, capture can include the system 100 receiving the data objects from the communication modalities 103. The capture process 106 can allow the system 100 to receive the data object from the communication modality 103 without interrupting or delayed the transmission of the communication (e.g., data object) to the intended recipient or requiring the sender to transmit the communication (e.g., data object) to the system 100.

The capture process 106 can include the API call 115, metadata fetching 118, and exporting 121. The system 100 can receive the data objects from the communication modalities 103 as the API call 115. In some embodiments, the system 100 can normalize the data objects received from the API call 115. For example, the system 100 can normalize the data objects into a predefined data structure with predefined fields and formatting. As an example, a data object representing a text message can be normalized into the same predefined data structure as a data object representing a video call. The system 100 can enrich the data objects using the metadata fetching 118. For example, if the data object represents a text message, the system 100 can look up and enrich the data object with a location associated with the area code. As another example, if the data object represents an email, the system 100 can look up and enrich the data object with the sender’s identity. The system 100 can export 121 the normalized and enriched data object to the API call 124. The API call 124 can place the data objects in a queue 127 until the system 100 is able to perform the archive process 109.

The archive process 109 can include the data processing 130, archiving the data store 107, and indexing 136 the archived data objects. The data processing 130 can include extracting attachments or shared documents. For example, an email can include an attachment and the data processing 130 can extract the attachment from the data object representing the email so that the attachment can be archived and indexed both individually and with the data object representing the email. The data processing 130 can include determining a state associated with the data object. The data processing 130 can include associating data objects generated by different communication modalities 103. For example, users can start a conversation on a first communication modality and then continue the conversation on a second communication modality. The data processing 130 can identify that the conversation on the first communication modality is associated with the conversation on a second communication modality and create an association among the data objects. The association can be stored as meta data as part of or separate from the data object. The data object can be archived in the data store 107. Once the data object has been archived, the data object cannot be modified or deleted. For example, the data store 107 can store the data object as immutable. The data objects stored in the data store 107 can be indexed 136. For example, the data objects can be tagged with metadata, such as keywords, and indexed based on the data object’s fields (e.g., data, sender, recipient, subject, attachments, communication modality). Once indexed 136, the data objects in the data store 107 can be searched, read, and provided in response to a compliance requirement or discovery request.

The reconciliation process 114 can include receiving the log entries 111, 112, and 113 at the log store 139 and reconciling the logs 142. Reconciling the logs 142 can identify if any data objects generated by the communication modalities 103 were not archived in the data store 107. For example, specific data objects generated by the communication modalities 103 can be identified as missing from the data store 107. Reconciling the logs 142 can include comparing the total number of entries in the log entries 111, 112, and 113 and comparing specific fields between the log entries 111, 112, and 113. For example, the log entry 113 can be compared with the log entry 111 to determine that a specific data object did not complete the capture process 106. As another example, the log entry 111 can be compared with the log entry 112 to determine that a specific data object did not complete the archive process 109 and has not been archived in the data store 107.

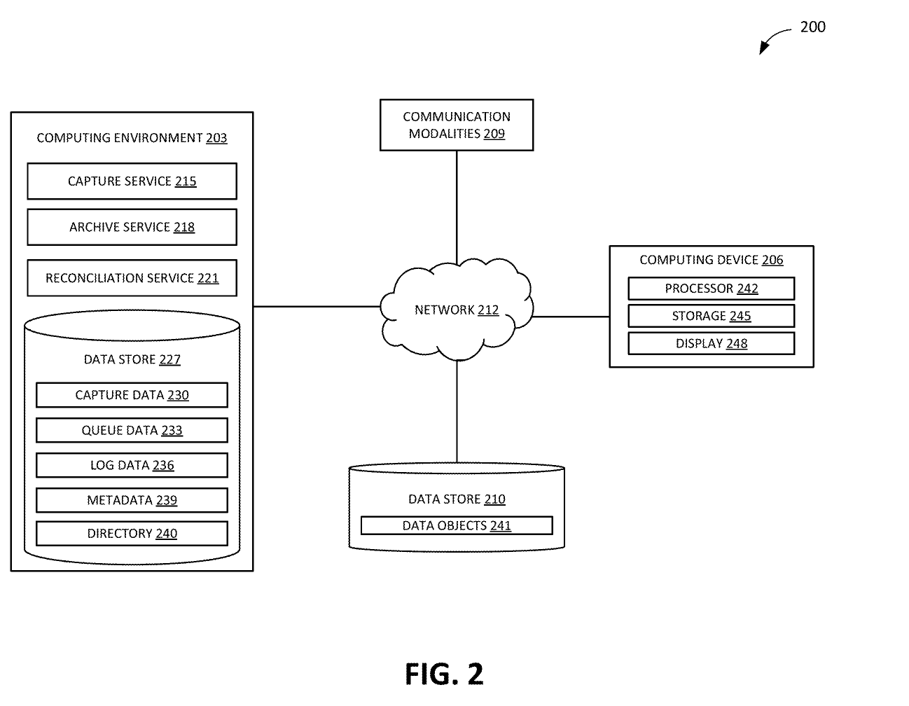

Referring now to FIG. 2, shown is an exemplary networked environment 200 for the end-to-end reconciliation system according to various embodiments of the present disclosure. As will be understood and appreciated, the exemplary networked environment 200 shown in FIG. 2 represents merely one approach or embodiment of the present system, and other aspects are used according to various embodiments of the present system. Exemplary networked environment 200 can include, but is not limited to, a computing environment 203 connected to one or more computing devices 206, one or more communication modalities 209, and the data store 210 over a network 212.

The elements of the computing environment 203 can be provided via one or more computing devices that may be arranged, for example, in one or more server banks or computer banks or other arrangements. Such computing devices can be located in a single installation or may be distributed among many different geographical locations. For example, the computing environment 203 can include one or more computing devices that together may include a hosted computing resource, a grid computing resource, or any other distributed computing arrangement. In some cases, the computing environment 203 can correspond to an elastic computing resource where the allotted capacity of processing, network, storage, or other computing-related resources may vary over time. Regardless, the computing environment 203 can include one or more processors and memory having instructions stored thereon that, when executed by the one or more processors, cause the computing environment 203 to perform one, some, or all of the actions, methods, steps, or functionalities provided herein.

The computing environment 203 can include a capture service 215, an archive service 218, a reconciliation service 221, and a data store 227. The capture service 215, the archive service 218, and the reconciliation service 221 can correspond to one or more software executables that can be executed by the computing environment 203 to perform the functionality described herein. While the capture service 215, the archive service 218, and the reconciliation service 221 are described as different services, it can be appreciated that the functionality of these services can be implemented in one or more different services executed in the computing environment 203. Various data can be stored in the data store 227, including but not limited to, the capture data 230, the queue data 233, the log data 236, the metadata 239, and the directory 240.

The capture service 215 can perform the capture process 106. The capture service 215 can receive the data objects from the communication modalities 209 and prepare the data objects for the archive process 109. The capture service 215 can receive the data objects from the communication modalities 209 via an API call. The archive service 215 can normalize the data objects into a predefined data structure with predefined fields and formatting. As an example, a data object representing a text message can be normalized into the same predefined data structure as a data object representing a video call. The capture service 215 can fetch metadata for each data object and add the metadata to fields in the predefined data structure. The capture service 215 can fetch metadata 239 from the data store 227 and/or the communication modalities 209. The metadata can include any data associated with the data objects, including but not limited to, the sender, the recipient, one or more groups within an organization, location, data, time, the originating communication modality 209, and any data associated with the foregoing. The capture service 215 can export the data objects by saving the data objects as the capture data 230 for retrieval by an API call.

The archive service 218 can perform the archive process 109. The archive service 218 can retrieve the data objects from the capture data 230 via an API call and save the data objects in a queue as the queue data 233. The data objects in the queue can be accessed by the archive service 218 for data processing. As will be understood, the archive service 218 can be limited in the amount or volume of data objects that can be processed simultaneously. The queue can allow the archive service 218 to access the data objects when the archive service 218 has new capacity for data processing.

The archive service 218 can perform data processing so that data objects may be saved in the data store 210. For example, the archive service 218 can extract attachments or shared documents from the data objects. As another example, the archive service 218 can determine a state associated with the data object. As another example, the archive service 218 can associate multiple data objects. For example, the archive service 218 can associate multiple data objects from a conversation thread (e.g., multiple communications from the same communication modalities 209. As another example, the archive service 218 can associate multiple data objects from different communication modalities 209 (e.g., communication begins on a first communication modality and continues on a second, different communication modality).

The archive service 218 can save the data objects in the data store 210 as the data objects 241. The archive service 218 can index the data objects saved in the data store 210 by creating the directory 240. The directory 240 can include a record of any of the metadata included in the data objects. The metadata can act as tags that can be organized within the directory 240. The directory 240 can be searched based on the tags and the directory 240 can link to the associated data object saved in the data store 210.

The reconciliation service 221 can determine if a data object transmitted by the communication modalities 209 is archived in the data store 210. The reconciliation service 221 can compare the data objects transmitted by the communication modalities 209, and the data objects saved in the data store 210. For example, the reconciliation service 221 can determine that a data object transmitted by the communication modalities 209 is not archived in the data store 210. The reconciliation service 221 can compare log entries. The log entries can represent a record of the data objects at different points in the capture process 106 and the archive process 109. The log entries can be generated by the communication modalities 209 and can represent the data objects transmitted by the communication modalities 209 to the capture service 215. The log entries can be generated by the capture service 215 or the reconciliation service 221 and can represent the data objects received by the capture service 215. The log entries can be generated by the capture service 215 or the reconciliation service 221 and can represent the data objects that have successfully completed the capture process 106. The log entries can be generated by the archive service 218 or the reconciliation service 221 and can represent the data objects that have successfully completed data processing in the archive process 109 and are ready to be saved in the data store 210.

Based on the comparison on the log entries and the data objects, the reconciliation service 221 can determine an error. As will be understood, the error can cause one or more data objects to be excluded from the data store 210 (e.g., one or more of the data objects transmitted by the communication modalities 209 is not saved in the data store 210). The errors can include, but are not limited to, the capture service 215 not receiving a data object transmitted by the communication modalities 209, failure to complete the capture process 106, and failure to complete the archive process 109. Based on the comparison and the determined error, the reconciliation service 221 can performed a remedial action. The remedial action can depend on the comparison and determined error. The remedial action can resolve the error and save the excluded data objects in the data store 210.

According to various embodiments, the computing device 206 can include any device capable of accessing network 212 including, but not limited to, a computer, smartphone, tablets, or other device. The computing device 206 can include a processor 242 and storage 245. The computing device 206 can include a display 248 on which various user interfaces can be rendered to allow users to configure, monitor, control, and command various functions of networked environment 200. In various embodiments, computing device 206 can include multiple computing devices. Regardless, the computing device 206 can include one or more processors and memory having instructions stored thereon that, when executed by the one or more processors, cause the computing device 206 to perform one, some, or all of the actions, methods, steps, or functionalities provided herein.

The communication modalities 209 can include any communication system capable of generating a communication. The communication modalities 209 can include but not limited to, email systems, phones, messaging systems, including text messaging and direct messaging, social media, collaboration platforms, video and audio conferencing platforms. The communication modalities 209 can register an API call with the capture service 215. Once the API call is registered with the capture service 215, each time that the communication modalities 209 generates a communication, the API call can transmit the communication to the capture service 215. The communication can be transmitted to the capture service 215 in the original format (e.g., email, text message, direct message, video, audio) or as a data object in the predefined data structure.

The data store 210 can include a write once, read many (e.g., WORM) storage. Once a data object is saved in the data store 210 as the data objects 241, the data objects can be read (e.g., viewed, downloaded, transmitted), but may not be deleted or modified.

The network 212 includes, for example, the Internet, intranets, extranets, wide area networks (WANs), local area networks (LANs), wired networks, wireless networks, or other suitable networks, etc., or any combination of two or more such networks.

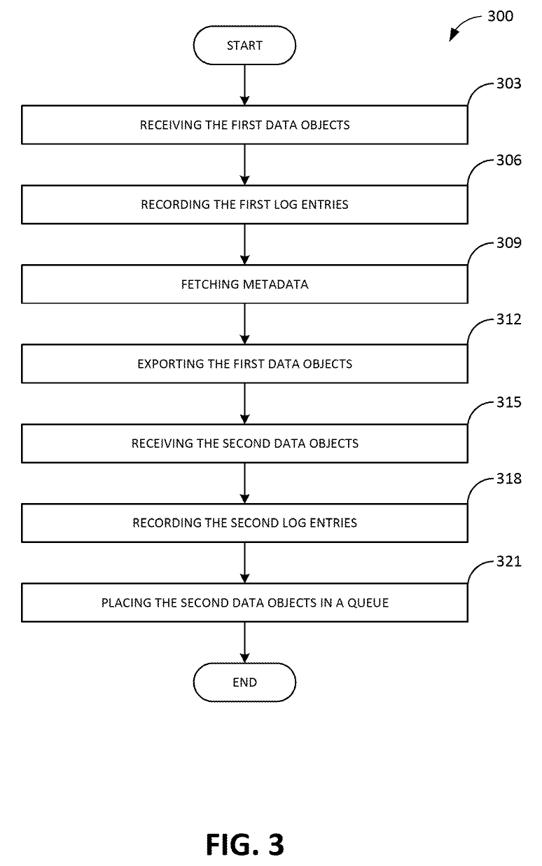

Referring now to FIG. 3, shown is an exemplary, capture process 300 according to various embodiments of the present disclosure. As will be understood by one having ordinary skill in the art, the steps and processes shown in FIGS. 3–5 may operate concurrently and continuously, are generally asynchronous and independent, can be performed in part or in whole by a combination of one or more of the computing environment 203, the computing device 206, the communication modalities 209, and the data store 210 and are not necessarily performed in the order shown and various steps can be executed linearly or in parallel. Process 300 can be performed entirely, partially, or in coordination with the capture service 215, the archive service 218, and the reconciliation service 221.

The foregoing disclosure references first data objects, second data objects, and third data objects. The data objects can include any communications generated by the communication modalities 209 or data structures representing communications generated by the communication modalities 209. First, second, and third can be used to distinguish different sets of data objects received or transmitted at different steps in capture process 106 and the archive process 109. For example, the third data objects can include all or some of the second data objects and/or the first data objects. As another example, the second data objects can include all or some of the first data objects. The first data objects can include the data objects transmitted by the communication modalities 209. The second data objects can include the data objects exported during the capture process 106. The third data objects can include the data objects archived during the archive process 109. As will be understood by those having ordinary skill in the art, the third data objects may not include all of the second data objects or all of the first data objects due to an error. Further, the second data objects may not include all of the first data objects due to an error. The errors can include errors during the transmission of the data objects from the communication modalities 209, the capture process 106, the API call 124, the queue 127, and/or the archive process 109. For example, the second data objects may not include all of the first data objects due to an error during the capture process 106 or if the capture service 215 does not receive the first data objects from the communication modalities 209. As another example, the third data objects may not include all of the second data objects due to an error during the archive process 109.

At step 303, the process 300 can include receiving the first data objects. The capture service 215 can receive the first data objects from the communication modalities 209. The first data objects can include any communications generated by the communication modalities 209 (e.g., emails, text messages, direct messages, audio and video calls and messages, conversation threads, attachments, shared documents). For example, the first data objects can be received in their original data structure, file type, and/or format generated by the communication modalities 103. As another example, the first data objects can be normalized into a predefined data structure with predefined fields and formatting. As an example, a data object representing a text message can be normalized into the same predefined data structure as a data object representing a video call. The capture service 215 can receive the first data objects via an API call. The first data objects can be received from any of the communication modalities 209 (e.g., email services, messaging service, phone service, mobile devices, social media platforms, collaboration platforms). The first data objects can be saved as the capture data 230.

At step 306, the process 300 can include recording the first log entries. The reconciliation service 221 can record the first log entries. The first log entries can represent a record of the first data objects. The first log entries can include an entry for each of the first data objects and a total number of first data objects. Each of the first log entries can correspond to each of the first data objects. Recording the first log entries can include the reconciliation service 221 receiving the first log entries or generating the first log entries and saving the log entries as the log data 236. In some embodiments, the first log entries can represent the record of the first data objects received by the capture service 215 at the step 303. In some other embodiments, the first log entries can represent the record of the first data objects transmitted to the capture service 215 by the communication modalities 209. For example, the reconciliation service 221 can receive the first log entries from the communication modalities 209. As another example, the reconciliation service 221 can generate the first log entries by creating an entry for each of the first data objects received by the capture service 215. The first log entries can be saved as the log data 236.

In some embodiments, if the first log entries are received by the reconciliation service 215, the first log entries may differ from the first data objects received by the capture service 221. For example, the first log entries can include a total number of first data objects greater than the total number of first data objects received by the capture service 215. In this example, the difference between the total number of first objects included in the first log entries and the total number of first data objects received by the capture service 215 can indicate that the capture service 215 did not receive all or some of the first data objects transmitted by the communication modalities 209.

At step 309, the process 300 can include fetching metadata. The capture service 215 can fetch the metadata. The metadata can include any data used to enrich the first data objects. For example, the capture service 215 can normalize the first data objects into a predefined data structure with predefined fields and formatting. The capture service 215 can fetch any metadata and add the fetched metadata to all or some of the fields in the predefined data structure. As an example, if a first data object represents a text message or phone call, the capture service 215 can look up the area code for the associated phone number and add the location to a field in the predefined data structure. As another example, if a first data object represents an email, the capture service 215 can fetch the sender’s identity based on the email address associated with the email. As another example, the capture service 215 can format the dates included in the first data objects into a predefined format. As another example, the capture service 215 can add groups (e.g., groups within organization) for the sender and recipient. As another example, the capture service 215 can add a location for the sender and recipient. In some embodiments, the predefined data structure can include required fields (e.g., fields that must include some data). The capture service 215 can assign identifiers to each data object. The capture service 215 can assign identifiers to each communication session. The metadata can be used as tags. Once the data objects are archived, the data objects can be indexed and searched based on the tags.

At step 312, the process 300 can include exporting the first data objects. The capture service 215 can export the first data objects. The first data objects can be exported for retrieval by an API. Exporting the first data objects can include saving the first data objects as the capture data 233. The first data objects can be exported in the predefined data structure including the metadata fetched and added to the fields in the data structure at the step 309. Exporting the first data objects can complete the capture process 106 described in FIG. 1. The second data objects can include the first data objects that have successfully completed the capture process 106 and have been successfully exported at step 312.

At step 315, the process 300 can include receiving the second data objects. The archive service 218 can receive the second data objects from the capture service 215. The second data objects can be received via an API call. For example, the API call can retrieve the second data objects from the capture data 230. As will be understood, the second data objects can include all or some of the first data objects that have successfully completed the capture process 106. In some embodiments, the second data objects may not include all of the first data objects.

At step 318, the process 300 can include recording the second log entries. The reconciliation service 221 can record the second log entries. The second log entries can represent a record of the second data objects. The second log entries can include an entry for each of the second data objects and a total number of second data objects. Each of the second log entries can correspond to each of the second data objects. For example, if the second data objects do not include all of the first data objects, the second log entries may not include all of the first log entries. As an example, the second log entries can include less entries than the number of entries in the first log entries. Recording the second log entries can include the reconciliation service 221 receiving the second log entries or generating the second log entries and saving the second log entries as the log data 236. In some embodiments, the second log entries can be generated by the capture service 215 representing a record of all the data objects that successfully completed the capture process 106. In some other embodiments, the reconciliation service 221 can generate the second log entries by creating an entry for each of the second data objects received by the API call at the step 315. The second log entries can be saved as the log data 236.

At step 321, the process 300 can include placing the second data objects in a queue. The archive service 218 can place the second data objects in a queue. The queue can allow for the archive service 218 to quickly access the second data objects once ready for processing. Placing the second data objects in a queue can include saving the second data objects as the queue data 233. The queue can organize the second data objects as first in, first out, or first in, last out.

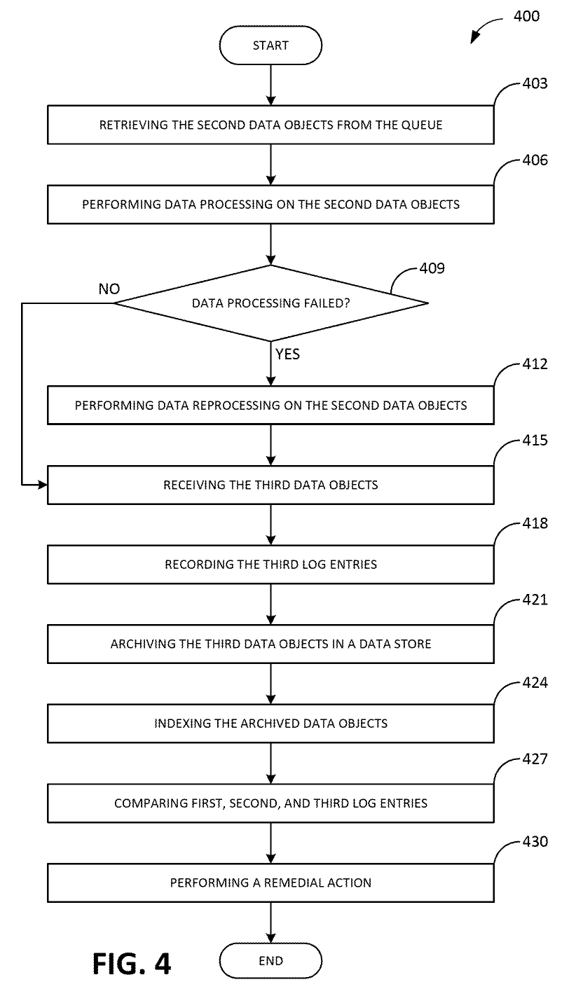

Referring now to FIG. 4, shown is an exemplary, archive process 400 according to various embodiments of the present disclosure. Process 400 can be performed entirely, partially, or in coordination with the capture service 215, the archive service 218, and the reconciliation service 221.

At step 403, the process 400 can include retrieving the second data objects from the queue. The archive service 218 can retrieve the second data objects from the queue. The second data objects can be retrieved from the queue based on the order organized within the queue. For example, the second data objects can be retrieved from the queue in the same order placed in the queue (e.g., first in, first out) or in reverse order (e.g., first in, last out).

At step 406, the process 400 can include performing data processing on the second data objects. The archive service 218 can perform data processing on the second data objects. The archive service 218 can extract attachments or shared documents from the second data objects. For example, if a data object represents an email with an attachment, the archive service 218 can extract the attachment. Once extracted, the attachment can be archived and indexed both individually and with the data object representing the email. As another example, the archive service 218 can determine a state associated with the data object. As another example, the archive service 218 can associate related data objects generated by different communication modalities 209. For example, users can communicate on a first communication modality 209 and then continue the communication on a second communication modality 209. The archive service 218 can determine that the communications are associated and link the related second data objects. As another example, the archive service 218 can associate data objects representing a thread conversation with multiple communications (e.g., email thread, text message thread, instant message thread).

At step 409, the process 400 can include determining if the data processing failed. The archive service 218 can determine if the data processing at the step 406 failed. As will be understood, data processing at the step 406 may fail to some of the second data objects, but not all of the second data objects. For example, the data processing at the step 406 can fail because of size limitations (e.g., size of the data objects, size of attachments or documents, size of conversation thread). As an example, the data processing may fail due to a data object exceeding a data object size limitation. As another example, the data processing may fail due to an attachment or document exceeding an attachment or document size limitation. As another example, the data processing may fail due to a data objects representing a conversation thread exceeding a conversation thread limitation. The data processing at the step 406 can fail due to missing metadata. For example, if the predefined data structure includes required fields, the data processing can fail due to a required field missing metadata. As another example, the data processing at the step 406 can fail due to incorrect state identification. If data processing at the step 406 failed, the process 400 can proceed to the step 412. If the data processing at the step 406 did not fail, the process 400 can proceed to the step 415.

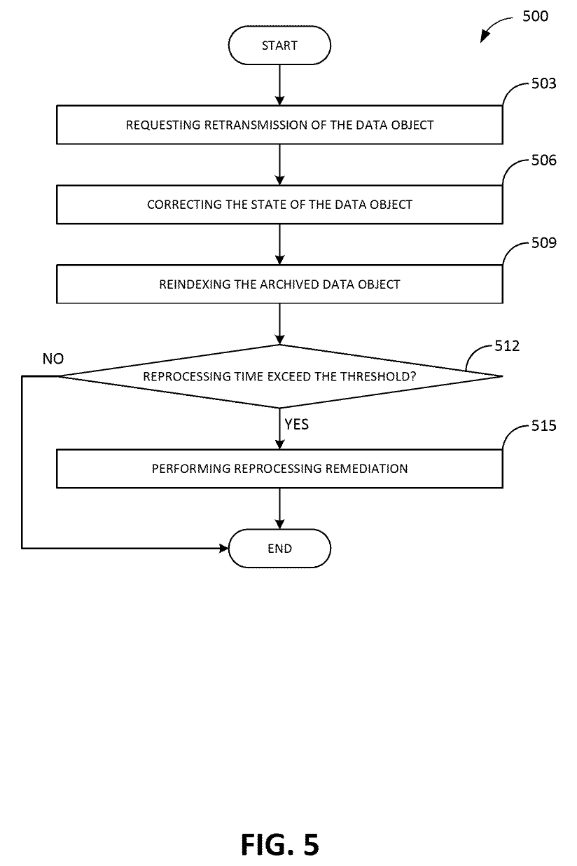

At step 412, the process 400 can include performing data reprocessing on the second data objects. The archive service 218 can perform data reprocessing on the second data objects. For example, the data reprocessing can include adjusting size limitations (e.g., size of the data objects, size of attachments or documents, size of conversation thread) and re-extracting attachments and documents. As another example, the data reprocessing can include correcting the state associated with the second data objects. As another example, the data reprocessing can include re-retrieving the second data objects from the queue. The data reprocessing at the step 412 can include re-attempts of any of the data processing techniques at the step 406. As will be understood, the step 412 will be discussed further with reference to FIG. 5.

At step 415, the process 400 can include receiving the third data objects. The archive service 218 can receive the third data objects. The third data objects can include the second data objects that have successfully completed data processing at the steps 406–412. As will be understood, the third data objects can include all or some of the second data objects that have successfully completed the data processing at the steps 406–412. In some embodiments, the third data objects may not include all of the second data objects.

At step 418, the process 400 can include recording the third log entries. The reconciliation service 221 can record the third log entries. The third log entries can represent a record of the third data objects. The third log entries can include an entry for each of the third data objects and a total number of third data objects. Each of the third log entries can correspond to each of the third data objects. For example, if the third data objects do not include all of the second data objects, the second log entries may not include all of the first log entries. As an example, the third log entries can include less entries than the number of entries in the second log entries. Recording the third log entries can include the reconciliation service 221 receiving the third log entries or generating the third log entries and saving the third log entries as the log data 236. In some embodiments, the third log entries can be generated by the archive service 218 representing a record of all the data objects that successfully completed the data processing at the steps 406–412. In some other embodiments, the reconciliation service 221 can generate the third log entries by creating an entry for each of the third data objects that has completed the data processing at the steps 406–412. The third log entries can be saved as the log data 236.

At step 421, the process 400 can include archiving the third data objects. The archive service 218 can archive the third data objects in the data store 210 as the data objects 241. Archiving the third data objects can include saving the third data objects in the data store 210. The data store 210 can include write once, read many (“WORM”) storage. Once the third data objects are archived in the data store 210, the third data objects may be read, but may not be deleted or modified.

At step 424, the process 400 can include indexing the third data objects. The archive service 218 can index the third data objects in the data store 210. Indexing the third data objects can include creating the directory 240. The directory 240 can represent a record of the metadata included in the third data objects. The metadata can act as tags that can be searched and organized (e.g., based on sender, recipient, group, data, topic, location). The directory 240 can be searched and can be linked to the associated data objects 241 in the data store 210.

At step 427, the process 400 can include comparing the first log entries, the second log entries, and the third log entries. The reconciliation service 221 can compare the first log entries, the second log entries, the third log entries, and potentially any number of other entires. Comparing the log entries can include comparing the total number of entries in each log and/or comparing each of the individual entries. Comparing the log entries can determine an error based on the log entries and/or the data objects. As will be understood, the error can cause one or more data objects to be excluded from the data store 210 (e.g., one or more of the data objects transmitted by the communication modalities 209 is not saved in the data store 210). For example, the determined error can include, but is not limited to, the capture service 215 not receiving a data object from the communication modalities 209, failure to complete the capture process 106, and/or failure to complete the archive process 109. Comparing the log entries can determine that a data object transmitted by the communication modalities 209 was not archived in or was excluded from the data store 210.

For example, if the first log entries are generated by the communication modalities 209, comparing the first log entries to the second log entries can determine that one of the first data objects was not received by the capture service 215 or failed to complete the capture process 106. As another example, comparing the second log entries to the third log entries can determine that a second data object failed data processing and/or was unable to be archived in the data store 210. As another example, comparing the first log entries to the third log entries can determine that a first data object failed data processing and/or was unable to be archived in the data store 210. The log entries can be compared to the data objects. For example, first log entries can be compared to the first data objects to confirm that the capture service 215 received all of the data objects transmitted by the communication modalities 209. As another example, the second log entries can be compared to the second data objects to confirm that the second data objects successfully completed the capture process 106 and was successfully saved in the queue data 233. As another example, the third log entries can be compared to the third data objects to confirm that the third data objects were saved in the data store 210. As another example, the third log entries can be compared to the directory 240 to determine if indexing was successfully completed.

At step 430, the process 400 can include performing a remedial action. The capture service 215, the archive service 218, and/or the reconciliation service 221 can perform a remedial action. The remedial action can depend on the comparison performed at the step 427. For example, if the comparison determined that a first data object transmitted by the communication modalities 209 was never received by the capture service 215, the capture service 215 can request retransmission from the communication modalities. As another example, if the comparison determined that a second data object failed to complete data processing, the archive service 218 can retrieve the second data object from the queue. As another example, if the comparison determined that a second data object or a third data object failed to be archive in the data store 210, the archive service 218 can rearchive and reindex the missing data object. The comparison and the error determined at the step 427 and the remedial action can be displayed on a dashboard. As will be understood, the step 430 will be discussed further with reference to FIG. 5.

Referring now to FIG. 5, shown is an exemplary, remedial process 500 according to various embodiments of the present disclosure. Process 500 can be performed entirely, partially, or in coordination with the capture service 215, the archive service 218, and the reconciliation service 221. As will be understood, the process 500 can operate concurrently with or in place of the step 412 and/or step 430 in the process 400. Further, the process 500 can depend on the comparison performed at the step 427. For example, none, some, or all of the steps in the process 500 may be performed depending on the comparison performed at the step 427. The step 412, the step 430, and/or the process 500 can initiate a timer. If the determined error is resolved, the timer can be stopped. If the determined error continues, the timer can continue. Once the timer exceeds a predefined threshold, the reconciliation service 221 can transmit an alert.

At step 503, the process 500 can include requesting retransmission of the data object. The capture service 215 and/or the archive service 218 can request retransmission of the data object. The request for retransmission can depend on the comparison performed at the step 427. For example, the capture service 215 can request retransmission of a first data object from the communication modalities 209. As another example, the archive service 218 can retrieve a second data object from the queue.

At step 506, the process 500 can include correcting a state associated with a data object. The archive service 218 can correct a state associated with a data object. For example, the archive service 218 can correct a state associated with a second data object or a third data object depending on the determination at the step 409.

At step 509, the process 500 can include reindexing the archived data object. The archive service 218 can reindex the archived data object. For example, the reconciliation service 221 can compare the third log entries to the directory 240 to determine if a third data object is excluded from the directory 240. If the reconciliation service 221 determines that, based on the comparison, the directory 240 does not include all of the third data objects based on the third log entries, the archive service 218 can reindex the third data object excluded from the directory 240.

At step 512, the process 500 can include determining if the timer exceeds a threshold. The reconciliation service 221 can determine if the timer exceeds a threshold. The steps 412, the step 430, and/or the process 500 can initiate the timer. The timer can continue until the error determined at the step 427 is resolved. For example, if the error is resolved, the timer can be stopped. As another example, if the error is not resolved, the timer can continue. The reconciliation service 221 can determine if the timer exceeds a predefined time threshold. The predefined time threshold can be any amount of time (e.g., 1 hour, 24 hours, 72 hours). If the timer does not exceed the predefined time threshold, the process 500 can end. If the timer does exceed the predefined time threshold, the process 500 can proceed to the step 515.

At step 512, the process 500 can include performing reprocessing remediation. The reconciliation service 221 can perform reprocessing remediation. Performing reprocessing remediation can include transmitting an alert. The alert can be displayed on the dashboard and prompt a user to perform reprocessing remediation.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer- executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein. While thresholds are discussed herein as being met when the threshold is exceeded, the system may determine a threshold is met when a value meets or exceeds the threshold.

Clause 1. A method, comprising: receiving, via one of one or more computing devices, a plurality of first data objects individually corresponding to a respective one of a plurality of communication modalities; storing, via one of the one or more computing devices, a plurality of first log entries individually corresponding to receiving a respective one of the plurality of first data objects; receiving, via one of one or more computing devices, a plurality of second data objects, wherein the plurality of second data objects were generated based in part on a respective one or more of the plurality of first data objects; storing, via one of the one or more computing devices, a plurality of second log entries individually corresponding to receiving a respective one of the plurality of second data objects; receiving, via one of one or more computing devices, a plurality of third data objects, wherein the plurality of third data objects were generated based in part on a respective one or more of the plurality of second data objects; storing, via one of the one or more computing devices, a plurality of third log entries individually corresponding to receiving a respective one of the plurality of third data objects; identifying, via one of the one or more computing devices, a failure to process one of the plurality of first data objects based on the plurality of second data objects and the plurality of third data objects; and performing, via one of the one or more computing devices, a remedial action based on identifying the failure to process the one of the plurality of first data objects.

Clause 2. The method of clause 1 or any other clause herein, wherein the remedial action comprises requesting retransmission of the one of the plurality of first data objects from a corresponding one of the plurality of communication modalities.

Clause 3. The method of clause 1 or any other clause herein, wherein identifying the failure to process one of the plurality of first data objects comprises determining that the one of the plurality of first data objects is excluded from an data store.

Clause 4. The method of clause 3 or any other clause herein, further comprising determining, via one of the one or more computing devices, that the one of the plurality of first data objects is included in the plurality of first log entries.

Clause 5. The method of clause 1 or any other clause herein, wherein the plurality of first data objects is received via an API.

Clause 6. The method of clause 1 or any other clause herein, further comprising placing the plurality of second data objects in queue.

Clause 7. The method of clause 1 or any other clause herein, further comprising: storing, via one of the one or more computing devices, the plurality of third data objects in a data store; and indexing, via one of the one or more computing devices, the plurality of third data objects.

Clause 8. The method of clause 7 or any other clause herein, wherein the plurality of third data objects in the data store cannot be deleted or modified.

Clause 9. A system, comprising: a memory device; and at least one computing device communicatively coupled to the memory device, the at least one computing device being configured to: receive a plurality of first data objects individually corresponding to a respective one of a plurality of communication modalities; store a plurality of first log entries individually corresponding to receiving a respective one of the plurality of first data objects; receive a plurality of second data objects, wherein the plurality of second data objects were generated based in part on a respective one or more of the plurality of first data objects; store a plurality of second log entries individually corresponding to receiving a respective one of the plurality of second data objects; receive a plurality of third data objects, wherein the plurality of third data objects were generated based in part on a respective one or more of the plurality of second data objects; store a plurality of third log entries individually corresponding to receiving a respective one of the plurality of third data objects; identify a failure to process one of the plurality of first data objects based on the plurality of second data objects and the plurality of third data objects; and perform a remedial action based on identifying the failure to process the one of the plurality of first data objects.

Clause 10. The system of clause 9 or any other clause herein, wherein the at least one computing device is further configured to perform one or more data processing techniques on the plurality of second data objects.

Clause 11. The system of clause 9 or any other clause herein, wherein the failure comprises a size of the one of the plurality of first data objects exceeding a size limitation.

Clause 12. The system of clause 9 or any other clause herein, wherein the one of the plurality of first data objects comprises a thread conversation and the failure comprises the thread conversation exceeding a thread limitation.

Clause 13. The system of clause 9 or any other clause herein, wherein the failure comprises incomplete metadata associated with the one of the plurality of first data objects.

Clause 14. The system of clause 9 or any other clause herein, wherein the remedial action comprises at least one of: retrieving the one of the plurality of second data objects from a queue; correcting a state associated with the one of the plurality of third data objects; or reindexing the one of the plurality of third data objects.

Clause 15. A non-transitory computer-readable medium embodying a program that, when executed by at least one computing device, cause the at least one computing device to: receive a plurality of first data objects individually corresponding to a respective one of a plurality of communication modalities; store a plurality of first log entries individually corresponding to receiving a respective one of the plurality of first data objects; receive a plurality of second data objects, wherein the plurality of second data objects were generated based in part on a respective one or more of the plurality of first data objects; store a plurality of second log entries individually corresponding to receiving a respective one of the plurality of second data objects; receive a plurality of third data objects, wherein the plurality of third data objects were generated based in part on a respective one or more of the plurality of second data objects; store a plurality of third log entries individually corresponding to receiving a respective one of the plurality of third data objects; identify a failure to process one of the plurality of first data objects based on the plurality of second data objects and the plurality of third data objects; and perform a remedial action based on identifying the failure to process the one of the plurality of first data objects.

Clause 16. The non-transitory computer-readable medium of clause 15 or any other clause herein, wherein the program further causes the at least one computing device to: receive the plurality of first log entries from the respective one of the plurality of communication modalities.

Clause 17. The non-transitory computer-readable medium of clause 16 or any other clause herein, wherein the program further causes the at least one computing device to: perform a comparison of the plurality of first log entries with at least one of: the plurality of second log entries or the plurality of third log entries.

Clause 18. The non-transitory computer-readable medium of clause 15 or any other clause herein, wherein the program further causes the at least one computing device to generate a dashboard comprising the comparison.

Clause 19. The non-transitory computer-readable medium of clause 15 or any other clause herein, wherein the plurality of third log entries is generated in response to performing one or more data processing techniques on the plurality of second data objects.

Clause 20. The non-transitory computer-readable medium of clause 15, wherein the plurality of second data objects comprises at least one of the plurality of first data objects and the plurality of third data objects comprises at least one of the plurality of second data objects.

These and other aspects, features, and benefits of the claims will become apparent from the detailed written description of the aforementioned aspects taken in conjunction with the accompanying drawings, although variations and modifications thereto may be effected without departing from the spirit and scope of the novel concepts of the disclosure.

What is claimed is:

1. A method, comprising:
receiving, via one of one or more computing devices, a plurality of first data objects individually corresponding to a respective one of a plurality of communication modalities;
storing, via one of the one or more computing devices, a plurality of first log entries individually corresponding to receiving a respective one of the plurality of first data objects;
receiving, via one of one or more computing devices, a plurality of second data objects, wherein the plurality of second data objects were generated based in part on a respective one or more of the plurality of first data objects;
storing, via one of the one or more computing devices, a plurality of second log entries individually corresponding to receiving a respective one of the plurality of second data objects;
receiving, via one of one or more computing devices, a plurality of third data objects, wherein the plurality of third data objects were generated based in part on a respective one or more of the plurality of second data objects;
storing, via one of the one or more computing devices, a plurality of third log entries individually corresponding to receiving a respective one of the plurality of third data objects;
identifying, via one of the one or more computing devices, a failure to process one of the plurality of first data objects based on the plurality of second data objects and the plurality of third data objects; and
performing, via one of the one or more computing devices, a remedial action based on identifying the failure to process the one of the plurality of first data objects.

2. The method of claim 1, wherein the remedial action comprises requesting retransmission of the one of the plurality of first data objects from a corresponding one of the plurality of communication modalities.

3. The method of claim 1, wherein identifying the failure to process one of the plurality of first data objects comprises determining that the one of the plurality of first data objects is excluded from an data store.

4. The method of claim 3, further comprising determining, via one of the one or more computing devices, that the one of the plurality of first data objects is included in the plurality of first log entries.

5. The method of claim 1, wherein the plurality of first data objects is received via an API.

6. The method of claim 1, further comprising placing the plurality of second data objects in queue.

7. The method of claim 1, further comprising:
storing, via one of the one or more computing devices, the plurality of third data objects in a data store; and
indexing, via one of the one or more computing devices, the plurality of third data objects.

8. The method of claim 7, wherein the plurality of third data objects in the data store cannot be deleted or modified.

9. A system, comprising:
a memory device; and
at least one computing device communicatively coupled to the memory device, the at least one computing device being configured to:
receive a plurality of first data objects individually corresponding to a respective one of a plurality of communication modalities;
store a plurality of first log entries individually corresponding to receiving a respective one of the plurality of first data objects;
receive a plurality of second data objects, wherein the plurality of second data objects were generated based in part on a respective one or more of the plurality of first data objects;
store a plurality of second log entries individually corresponding to receiving a respective one of the plurality of second data objects;
receive a plurality of third data objects, wherein the plurality of third data objects were generated based in part on a respective one or more of the plurality of second data objects;
store a plurality of third log entries individually corresponding to receiving a respective one of the plurality of third data objects;
identify a failure to process one of the plurality of first data objects based on the plurality of second data objects and the plurality of third data objects; and
perform a remedial action based on identifying the failure to process the one of the plurality of first data objects.

10. The system of claim 9, wherein the at least one computing device is further configured to perform one or more data processing techniques on the plurality of second data objects.

11. The system of claim 9, wherein the failure comprises a size of the one of the plurality of first data objects exceeding a size limitation.

12. The system of claim 9, wherein the one of the plurality of first data objects comprises a thread conversation and the failure comprises the thread conversation exceeding a thread limitation.

13. The system of claim 9, wherein the failure comprises incomplete metadata associated with the one of the plurality of first data objects.

14. The system of claim 9, wherein the remedial action comprises at least one of:
retrieving the one of the plurality of second data objects from a queue;
correcting a state associated with the one of the plurality of third data objects; or
reindexing the one of the plurality of third data objects .

15. A non-transitory computer-readable medium embodying a program that, when executed by at least one computing device, cause the at least one computing device to:
receive a plurality of first data objects individually corresponding to a respective one of a plurality of communication modalities;
store a plurality of first log entries individually corresponding to receiving a respective one of the plurality of first data objects;
receive a plurality of second data objects, wherein the plurality of second data objects were generated based in part on a respective one or more of the plurality of first data objects;
store a plurality of second log entries individually corresponding to receiving a respective one of the plurality of second data objects;
receive a plurality of third data objects, wherein the plurality of third data objects were generated based in part on a respective one or more of the plurality of second data objects;
store a plurality of third log entries individually corresponding to receiving a respective one of the plurality of third data objects;
identify a failure to process one of the plurality of first data objects based on the plurality of second data objects and the plurality of third data objects; and
perform a remedial action based on identifying the failure to process the one of the plurality of first data objects.

16. The non-transitory computer-readable medium of claim 15, wherein the program further causes the at least one computing device to:
receive the plurality of first log entries from the respective one of the plurality of communication modalities.

17. The non-transitory computer-readable medium of claim 16, wherein the program further causes the at least one computing device to:
perform a comparison of the plurality of first log entries with at least one of: the plurality of second log entries or the plurality of third log entries.

18. The non-transitory computer-readable medium of claim 15, wherein the program further causes the at least one computing device to generate a dashboard comprising the comparison.

19. The non-transitory computer-readable medium of claim 15, wherein the plurality of third log entries is generated in response to performing one or more data processing techniques on the plurality of second data objects.

20. The non-transitory computer-readable medium of claim 15, wherein the plurality of second data objects comprises at least one of the plurality of first data objects and the plurality of third data objects comprises at least one of the plurality of second data objects.
